(19) United States
(12) Patent Application Publication
(10) Pub. No.: US 2024/0114284 A1
(43) Pub. Date: Apr. 4, 2024

(54) EARPHONE

(71) Applicant: SANE Products Inc., Pasadena, CA (US)

(72) Inventors: Pei-Hsun LU, New Taipei City (TW); Christopher Michael MANCINI, Summerland, CA (US)

(21) Appl. No.: 18/376,639

(22) Filed: Oct. 4, 2023

Related U.S. Application Data
(60) Provisional application No. 63/412,920, filed on Oct. 4, 2022.

(51) Int. Cl. H04R 1/10; H04R 1/04

(52) U.S. Cl. CPC H04R 1/1075; H04R 1/04; H04R 1/1016; H04R 2201/107

(57) ABSTRACT

An earphone including a first earbud and a microphone device. The first earbud includes a housing and a motherboard at least partially disposed in the housing. The housing has a restricting surface. The restricting surface surrounds at least a part of the motherboard. The microphone device includes a shell, a circuit board, a connector and a restricting component. The circuit board is disposed in the shell. The connector protrudes from the circuit board and electrically connects the circuit board to the motherboard. The restricting component protrudes from the shell and rests on the restricting surface of the housing to restrict a movement of the shell and the housing.

### CROSS-REFERENCE TO RELATED APPLICATIONS

This non-provisional application claims priority under 35 U.S.C. § 119(a) on provisional patent application No(s). 63/412,920 filed in U.S.A. on Oct. 4, 2022, the entire contents of which are hereby incorporated by reference.

### TECHNICAL FIELD

The disclosure relates to an earphone, more particularly to an earphone including a microphone device.

### BACKGROUND

When playing mobile games, users often wear an earphone to recognize the details of the sounds or enhance the user experience. In such a case, it would be inconvenient to use separate microphone to receive sounds. Thus, some manufactures radially plug the audio connector of the microphone into the earphone to realize the electrical connection and integration of the microphone and the earphone.

However, there should be an insertion hole on the earphone for the audio connector to be plugged therein, which limits the axial size design of the earphone. In detail, the insertion hole hinders the reduction of the axial size of the earphone. Thus, the reduction of the overall weight of the earphone is hindered, and thus an ear hook is required to prevent the earphone from being detached from the ear.

### SUMMARY

The disclosure provides an earphone with reduced axial size and overall weight.

One embodiment of this disclosure provides an earphone including a first earbud and a microphone device. The first earbud includes a housing and a motherboard at least partially disposed in the housing. The housing has a restricting surface. The restricting surface surrounds at least a part of the motherboard. The microphone device includes a shell, a circuit board, a connector and a restricting component. The circuit board is disposed in the shell. The connector protrudes from the circuit board and electrically connects the circuit board to the motherboard. The restricting component protrudes from the shell and rests on the restricting surface of the housing to restrict a movement of the shell and the housing.

According to the earphone disclosed by above embodiments, the motherboard of the earphone is electrically connected to the circuit board of the microphone device via the connector, and the connector protrudes from the circuit board. Thus, the housing of the first earbud is not required to have any insertion hole for the audio connector. Accordingly, the axial size and thus the overall weight of the first earbud is allowed to be reduced. Also, the ear hook can be selectively omitted.

Further, since the restricting component rests on the restricting surface of the housing to restrict the movement of the shell and the housing, the shell and the housing are prevented from being moved relative to each other. Thus, the electrical connection between the circuit board and the motherboard created by the connector is ensured.

### BRIEF DESCRIPTION OF THE DRAWINGS

The present disclosure will become better understood from the detailed description given herein below and the accompanying drawings which are given by way of illustration only and thus are not intending to limit the present disclosure and wherein:

FIG. 1 is a perspective view of an earphone according to one embodiment of the disclosure;

FIG. 2 is a partially enlarged exploded view of the earphone in FIG. 1;

FIG. 3 is a partially enlarged exploded view of the earphone in FIG. 2 along another viewing angle;

FIG. 4 is another partially enlarged exploded view of the earphone in FIG. 1;

FIG. 5 is the partially enlarged exploded view of the earphone in FIG. 4 along another viewing angle; and

FIG. 6 is a partially enlarged view of an earphone according to another embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

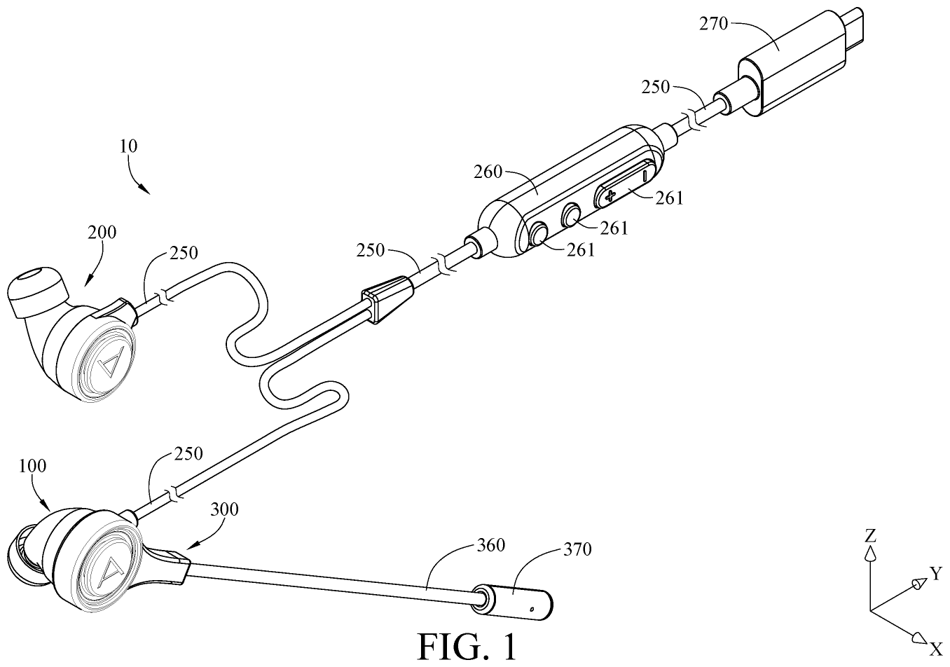

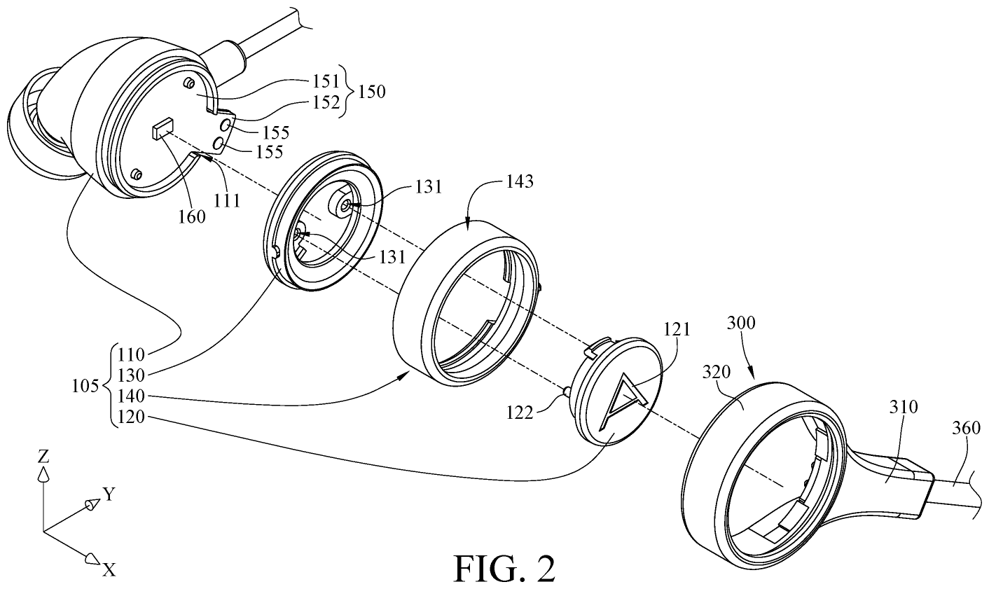

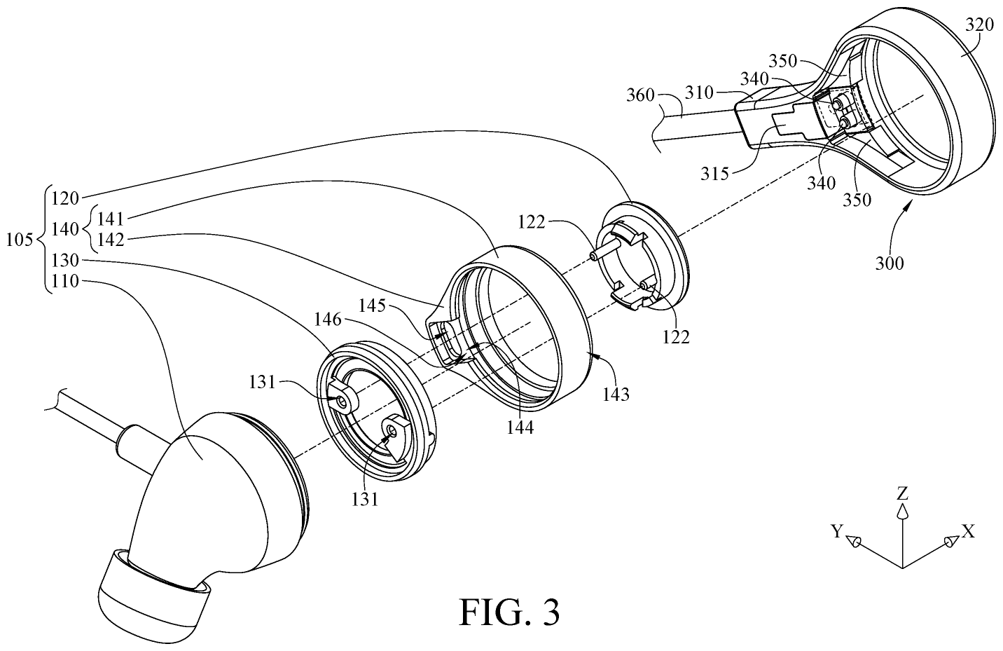

Please refer to FIGS. 1 to 3. FIG. 1 is a perspective view of an earphone 10 according to one embodiment of the disclosure. FIG. 2 is a partially enlarged exploded view of the earphone 10 in FIG. 1. FIG. 3 is a partially enlarged exploded view of the earphone 10 in FIG. 2 along another viewing angle.

In this embodiment, the earphone 10 is, for example, a wired earphone. The earphone 10 includes a first earbud 100, a second earbud 200, a wire 250, a controller 260, a connecting port 270 and a microphone device 300.

The first earbud 100 includes a housing 105, a motherboard 150, two electrical contacts 155 and a light emitting component 160.

In this embodiment, the housing 105 includes a base 110, a light guiding component 130, a mounting frame 140 and a cover 120. For example, the base 110 is in a barrel shape and has a circular radial cross-section. The base 110 has an opening 111. The light guiding component 130 is sleeved on a side of the base 110. The mounting frame 140 includes a sleeve part 141 and an assembling part 142. The sleeve part 141 is in, for example, a ring shape. The sleeve part 141 has a restricting surface 143. The sleeve part 141 is sleeved on the light guiding component 130. The assembling part 142 radially protrudes from the sleeve part 141, and has a recess 144 and a through hole 145. Further, the assembling part 142 is made of a magnetic material or any material that can be attracted by a magnet. The recess 144 is located on a side of the assembling part 142 that is located closest to the base 110. The through hole 145 is located on a bottom surface 146 forming the recess 144. The cover 120 is disposed on a side of the light guiding component 130 that is located farthest away from the base 110, and is surrounded by the sleeve part 141. The cover 120 has a visual pattern 121. The visual pattern 121 is located on a side of the cover 120 that is located farthest away from the light guiding component 130, and is exposed to the outside. In this embodiment, for example, the cover 120 has two positioning pins 122 and the light guiding component 130 has two positioning holes 131. The two positioning pins 122 are respectively positioned in the two positioning holes 131, such that the cover 120 and the light guiding component 130 are positioned with each other.

The motherboard 150 is disposed on the base 110. In this embodiment, the motherboard 150 includes a body part 151 and a protruding part 152. The body part 151 is disposed in the base 110 and is in, for example, a disk shape. The restricting surface 143 surrounds the body part 151. The protruding part 152 radially protrudes from the body part 151, and protrudes out of the base 110 through the opening 111. Also, the protruding part 152 is disposed in the recess 144. The two electrical contacts 155 are disposed on the protruding part 152.

The light emitting component 160 is disposed on the body part 151 of the motherboard 150. The light guiding component 130 is located between the cover 120 and the light emitting component 160, and is configured to guide the light emitted from the light emitting component 160 to the visual pattern 121 on the cover 120. Thus, the first earbud 100 can generate a vivid visual effect. In other embodiments without the demand of generating visual effect by light, the first earbud may not include the light emitting component, and the housing may not include the light guiding component.

The first earbud 100 and the second earbud 200 are connected to the controller 260 and the connecting port 270 via the wire 250. For example, the controller 260 has a plurality of buttons 261 to control the first earbud 100 and the second earbud 200. The connecting port 270 meets, for example, the USB Type-C specification. The connecting port 270 is configured to be plugged into an insertion hole of an external device such as a smartphone.

In other embodiments, the earphone may be a wireless earphone and thus may not include the second earbud 200, the wire 250, the controller 260 and the connecting port 270.

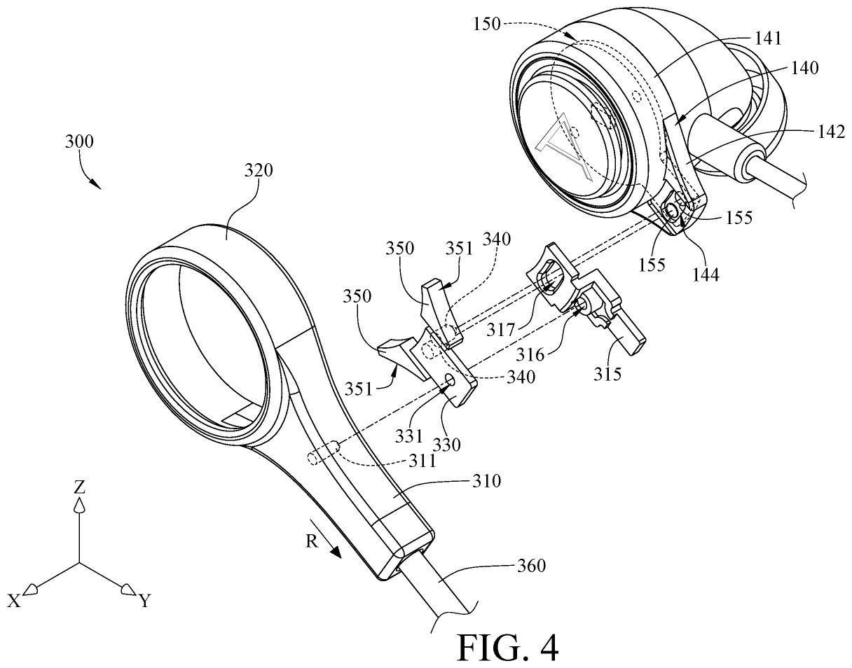

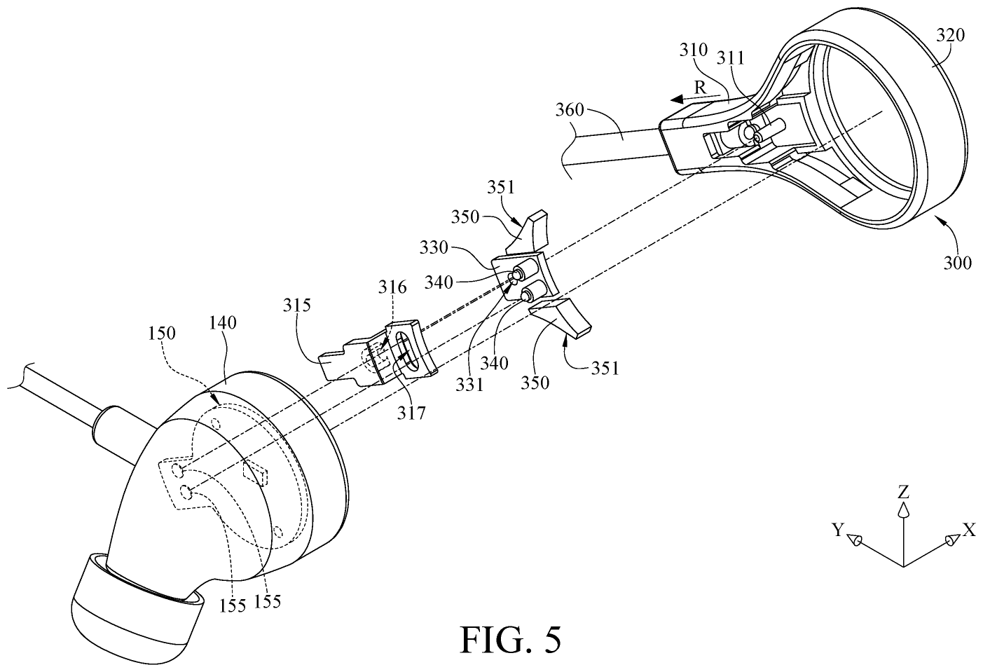

Please refer to FIGS. 3 to 5. FIG. 4 is another partially enlarged exploded view of the earphone 10 in FIG. 1. FIG. 5 is the partially enlarged exploded view of the earphone 10 in FIG. 4 along another viewing angle.

In this embodiment, the microphone device 300 includes a shell 310, a circuit board 330, a connector 340, an assembling cover 315, a restricting component 320, two magnets 350, a wire 360 and an audio receiver 370.

The circuit board 330 is disposed in the shell 310. The connector 340 protrudes from the circuit board 330, and electrically connects the circuit board 330 to the motherboard 150.

The assembling cover 315 is disposed on a side of the shell 310 that is located closest to the mounting frame 140, and has a first assembling hole 316 and a through hole 317 that are spaced apart from each other. The circuit board 330 has a second assembling hole 331. The shell 310 has an assembling protrusion 311 disposed through the first assembling hole 316 and the second assembling hole 331. The connector 340 is disposed through the through hole 317 and the through hole 145, and is in electrical contact with the two electrical contacts 155, thereby electrically connecting the circuit board 330 to the motherboard 150. In addition, in this embodiment, the connector 340 is, for example, a POGO PIN connector.

The restricting component 320 protrudes from the shell 310 and rests on the restricting surface 143 to restrict the movement of the shell 310 and the housing 105 along a radial direction R. The radial direction R is perpendicular to an axial direction (i.e., X-axis direction in the drawings). In this embodiment, the restricting component 320 is in, for example, a ring shape and is sleeved on the restricting surface 143, thereby enhancing the restriction of the movement of the shell 310 and the housing 105 along the radial direction R. However, the disclosure is not limited thereto. In other embodiments, the restricting component may be in a C-shape or any other shapes enabling the restriction of the movement of the shell and the housing along the radial direction.

The two magnets 350 are fixed to the shell 310 and are attracted on the assembling part 142, thereby restricting the movement of the shell 310 and the housing 105 along the axial direction (i.e., X-axis direction in the drawings). In addition, in this embodiment, the circuit board 330 is located between the two magnets 350, and thus an axial size (the size along X-axis direction) of the microphone device 300 is allowed to be further reduced. Moreover, the two magnets 350 each have an outer surface 351 facing away from the circuit board 330. The two outer surfaces 351 taper away from the sleeve part 141. That is, the two magnets 350 has a tapered shape along the radial direction R. Accordingly, the size of the shell 310 is allowed to be further reduced. In other embodiments, the magnets may not have the above tapered shape. Alternatively, in other embodiments, the microphone device may have one magnet. In still other embodiments, the microphone device may not include the magnet.

Please refer to FIGS. 1 and 4. The circuit board 330 is connected to the audio receiver 370 via the wire 360.

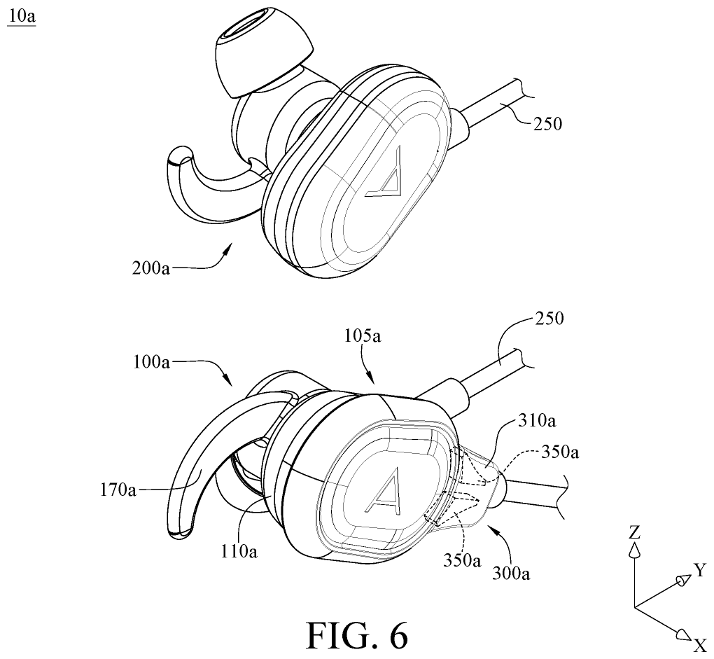

Please refer to FIG. 6. FIG. 6 is a partially enlarged view of an earphone 10a according to another embodiment of the disclosure. In this embodiment, the earphone 10a includes a first earbud 100a, a second earbud 200a, a wire 250 and a microphone device 300a. The main difference between this embodiment and the embodiment in FIGS. 1 to 5 is in that a housing 105a of the first earbud 100a is in a barrel shape and has an elliptical or oval radial cross section, and the first earbud 100a further includes an ear hook 170a disposed on a base 110a.

By designing the housing 105a (particularly the base 110a) into a barrel shape with elliptical or oval radial cross section, the volume of a shell 310a of the microphone device 300a is increased. In this way, the volume of magnets 350a can be increased to strengthen the magnetic force generated by the magnets 350a, thereby enhancing the axial restriction of the magnets 350a. Additionally, an accommodation space of the base 110a for the electronic components (e.g., circuit board) is expanded, thereby enabling the first earbud 100a to provide audio signals with improved quality. Also, the base 110a can fit the ear more tightly to prevent the first earbud 100a from being detached from the ear.

Due to the ear hook 170a, when a user wears the earphone 10a under specific conditions (e.g., when exercising), the first earbud 100a is ensured to be kept in the ear. However, the disclosure is not limited thereto. In other embodiments (e.g., the embodiment in FIGS. 1 to 5), the first earbud that is lightweight may not include the ear hook. Also, in this embodiment, the ear hook 170a and the base 110a are, for example, integrally formed as a single piece, but the disclosure is not limited thereto. In other embodiments, the ear hook may be detachably disposed on the base.

In order to highlight the difference between this embodiment and the embodiment in FIGS. 1 to 5, a part of the wire 250, the controller and the connecting port are omitted from FIG. 6. However, note that the earphone 10a may include the controller 260 and the connecting port 270 of the embodiment in FIGS. 1 to 5. In addition, the first earbud 100a may include the motherboard 150, the electrical contacts 155 and the light emitting component 160 of the embodiment in FIGS. 1 to 5, and the housing 105a of the first earbud 100a may include the base 110a, the light guiding component 130, the mounting frame 140 and the cover 120 of the embodiment in FIGS. 1 to 5. Moreover, the microphone device 300a may include the circuit board 330, the connector 340, the assembling cover 315, the restricting component 320, the wire 360 and the audio receiver 370 of the embodiment in FIGS. 1 to 5.

According to the earphone disclosed by above embodiments, the motherboard of the earphone is electrically connected to the circuit board of the microphone device via the connector, and the connector protrudes from the circuit board. Thus, the housing of the first earbud is not required to have any insertion hole for the audio connector. Accordingly, the axial size and thus the overall weight of the first earbud is allowed to be reduced. Also, the ear hook can be selectively omitted.

Further, since the restricting component rests on the restricting surface of the housing to restrict the movement of the shell and the housing, the shell and the housing are prevented from being moved relative to each other. Thus, the electrical connection between the circuit board and the motherboard created by the connector is ensured.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. An earphone, comprising:
a first earbud, comprising a housing and a motherboard at least partially disposed in the housing, wherein the housing has a restricting surface, and the restricting surface surrounds at least a part of the motherboard; and
a microphone device, comprising a shell, a circuit board, a connector and a restricting component, wherein the circuit board is disposed in the shell, the connector protrudes from the circuit board and electrically connects the circuit board to the motherboard, and the restricting component protrudes from the shell and rests on the restricting surface of the housing to restrict a movement of the shell and the housing.

2. The earphone according to claim 1, wherein the restricting component is in a ring shape and is sleeved on the housing.

3. The earphone according to claim 1, wherein the microphone device further comprises at least one magnet fixed to the shell and attracted to the housing.

4. The earphone according to claim 3, wherein the housing comprises a base, a mounting frame and a cover, the base is in a barrel shape and has a circular radial cross section, the motherboard is disposed in the base, the mounting frame comprises a sleeve part and an assembling part, the sleeve part is in a ring shape, the assembling part radially protrudes from the sleeve part, the sleeve part is sleeved on a side of the base, the restricting surface is located on the sleeve part, the cover is disposed on a side of the sleeve part that is located farthest away from the base, the restricting component is in a ring shape and sleeved on the mounting frame, and the at least one magnet is attracted to the assembling part.

5. The earphone according to claim 4, wherein the first earbud further comprises a light emitting component and the housing further comprises a light guiding component, the light emitting component is disposed on the motherboard, the light guiding component is sleeved on a side of the base, the sleeve part of the mounting frame is sleeved on the light guiding component, and the light guiding component is located between the cover and the light emitting component, and is configured to guide a light emitted from the light emitting component to a visual pattern of the cover.

6. The earphone according to claim 4, wherein the at least one magnet comprises two magnets, and the circuit board is located between the two magnets.

7. The earphone according to claim 6, wherein the two magnets each have an outer surface facing away from the circuit board, and the two outer surfaces of the two magnets taper away from the sleeve part.

8. The earphone according to claim 4, wherein the first earbud further comprises two electrical contacts, the motherboard comprises a body part and a protruding part, the body part is disposed in the base and is in a disk shape, the base has an opening, the protruding part radially protrudes from the body part and protrudes out of the base through the opening, the two electrical contacts are disposed on the protruding part, the assembling part of the mounting frame has a recess and a through hole, the through hole is located on a bottom surface forming the recess, the protruding part is disposed in the recess, and the connector is disposed through the through hole and in electrical contact with the two electrical contacts so as to electrically connect the circuit board to the motherboard.

9. The earphone according to claim 4, wherein the microphone device further comprises an assembling cover, the assembling cover is disposed on a side of the shell that is located closest to the mounting frame, and has a first assembling hole and a through hole spaced apart from each other, the circuit board has a second assembling hole, the shell has an assembling protrusion, the assembling protrusion is disposed through the first assembling hole and the second assembling hole, and the connector is disposed through the through hole.

10. The earphone according to claim 1, wherein the connector is a POGO PIN connector.

11. The earphone according to claim 1, wherein the housing is in a barrel shape and has an elliptical or oval radial cross section.
